(19) United States
(12) Patent Application Publication
(10) Pub. No.: US 2016/0364101 A1
(43) Pub. Date: Dec. 15, 2016

(54) METHOD FOR CONTROLLING REMOTE USER DISPLAY

(71) Applicant: Ricardo Spear, Orlando, FL (US)

(72) Inventor: Ricardo Spear, Orlando, FL (US)

(21) Appl. No.: 14/739,171

(22) Filed: Jun. 15, 2015

(51) Int. Cl. G06F 3/0484; H04L 29/08

(52) U.S. Cl. CPC G06F 3/0484; H04L 67/142

(57) ABSTRACT

A method for displaying information on a remote computer including the steps of (1) initiating an inquiry using the remote computer operated by a remote user in a remote session; (2) receiving the inquiry using a host computer operated by a host user in a host session; (3) providing a control command by the host user; (4) transmitting the control command from the host session to the remote session; (5) detecting the control command in the remote session; and (6) executing the control command in the remote session.

### FIELD OF THE INVENTION

The present invention relates to a method for a host user to control content viewed on the electronic device of one or more remote users. Specifically, the present invention relates to methods for a host user of a first electronic device to dynamically control or direct content viewed by one or more remote users of remote electronic devices.

### BACKGROUND OF INVENTION

Based upon a user request, known systems may send content that may refresh or update data in some applications, such as a chat application. This known method presents a large barrier in communication when items, including but not limited to, hyperlinks, requiring user interaction are sent to the remote user. In one known approach, which is presented for illustrative purposes only, a customer service representative (host user) may send a hyperlink directing a customer (remote user) to information relevant to the customer's inquiry. The information, by way of example and not as a limitation, may include product specifications, troubleshooting steps, or the like. The customer service representative may expect the customer to take action that would result in the remote device displaying, or otherwise presenting, the relevant information. By way of example, the customer may be expected to mouse click on a hyperlink to cause the relevant information to open in or be displayed by a different window than the one currently being viewed by the customer. The customer may be expected to mouse click on a hyperlink to update the content currently displayed in a window being viewed by the customer. Requiring the customer to take some action in response to the item sent by the customer service representative to the customer is a disadvantage of this known system.

Another disadvantage of the known system is that as more content is provided to the remote user, more activity is required from the remote user. Large modifications to the content provided to the remote user could require multiple interactions from the remote user, which would make this known method cumbersome to the remote user.

### BRIEF DESCRIPTION OF THE DRAWINGS

FIG. 1 is a block diagram of a system utilizing the inventive method for controlling a remote user display according to an embodiment of the present invention.

FIGS. 2 and 3 are diagrams of a host user's view of a host session on a website to be used by a host user to carry out the method of controlling a remote user display according to an embodiment of the present invention.

FIG. 4 is a block diagram of another system utilizing the inventive method of controlling a remote user display according to an embodiment of the present invention.

FIG. 5 is a flowchart depicting a method for controlling a remote user display according to an embodiment of the present invention.

FIG. 6 is another flowchart depicting a method for controlling a remote user display according to an embodiment of the present invention.

FIG. 7 is a diagram depicting a remote user's view of a remote session prior to the host user's issuance of any control command using a system for utilizing the inventive method of controlling a remote user display according to an embodiment of the present invention.

FIG. 8 depicts another flowchart depicting a method for controlling a remote user display according to an embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

The invention provides a way for a host user to modify remote web browsing sessions or application sessions without the need for remote user interaction in the session being modified. Known web-browsing and application sessions involve remote user interaction, such as hovering or clicking, to execute particular actions. In the present invention, it is possible to utilize a host user to send commands to a web browser or application, hereinafter referred to as a remote session, installed on the computer of one or more remote users. The web browser or application, hereinafter referred to as a host session, of the host user may execute commands that result in changes to the remote sessions of the one or more remote users. By way of illustration and not as a limitation, such commands may include a request for user interaction or modification or addition of elements including, but not limited to, photos, hyperlinks, inline frames, divisions or sections of code, videos, sessions, cookies, or the like. The inventive system and methods provide a new way to experience web browsing, applications, and social interactions between individuals.

In accordance with embodiments of the present invention, the host user may modify a remote user's browser session via any standard web protocol. This modification may be possible when the remote user is utilizing any web browser, application, or operating system. The method and system according to embodiments of the present invention may work across different user browser and operating system platforms. The system and methods of the present invention may be accomplished utilizing known web browsers and may not require the installation of any special software. The system and methods of the present invention may eliminate the need for action by the remote user. The inventive system and methods may also increase security by allowing the remote user's electronic device to respond to host user directed interactions through API functions. By way of illustration and not as a limitation, API functions may include resizing elements, inserting elements, modifying elements, retrieving logs, retrieving screen dimensions, displaying messages, displaying alert windows, requesting permissions, undoing previous actions, and the like.

An embodiment of the invention, as shown and described by the various figures and accompanying text provides a method to enhance a remote user's customer service experience. The method may utilize a network, a host computer, a host user, a remote user, and a remote computer.

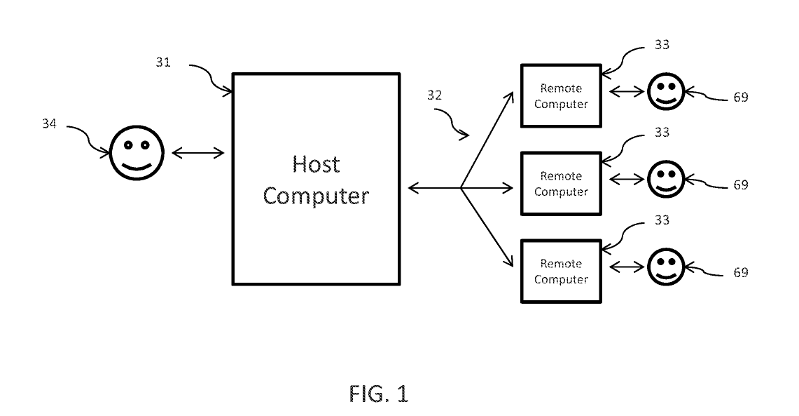

As depicted in FIG. 1, a host computer 31 may be connected to a network 32, which is also connected to one or more remote computers 33. The host computer 31 may be accessed by a host user 34. The host user 34 may input data to the host computer 31 utilizing a known input device, by way of example, but not limited to, a keyboard, mouse, or the like. The host computer 31 may output data to the host user 34 utilizing a known output device, by way of example, but not limited to, a monitor, display, printer, or the like. The one or more remote computers 33 may be accessed by one or more respective remote users 69. The respective one or more remote users 69 may input data to the respective one or more remote computers 33 utilizing a known input device, by way of example, but not limited to, a keyboard, mouse, or the like. The one or more remote computers 33 may output data to the respective one or more remote users 69 utilizing a known output device, by way of example, but not limited to, a monitor, display, printer, or the like.

The host computer 31 and the one or more remote computers 33 may be any computer known in the art. Illustrative, but not limiting, examples include desktop computers, laptop computers, smart phones, tablets, or the like. The one or more remote computers 33 may be disparate types of computers. By way of example, and not as a limitation, one or more remote computers 33 may be a laptop computer, one or more remote computers 33 may be a smart phone, and one or more remote computers 33 may be a tablet device. Similarly, the host computer 31 may be any type of computer and may interface with one or more remote computers 33 of disparate type.

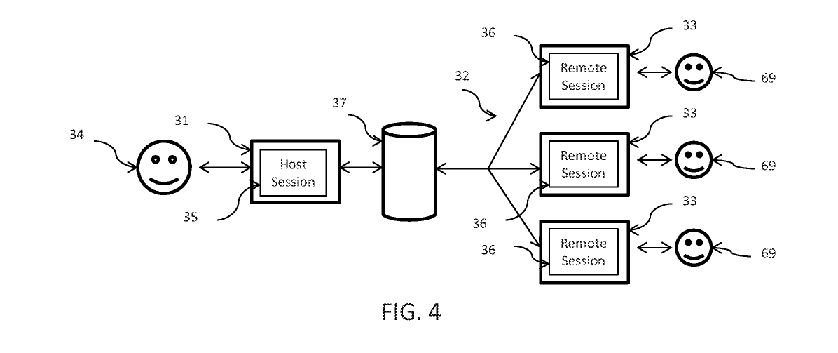

As further depicted in FIG. 4, the host computer 31 may execute a host session 35. The one or more remote computers 33 may each host a respective remote session 36. The host session 35 may control the respective remote sessions 36 by sending control commands to a socket server 37 in electrical communication with the network 32. The socket server 37 may direct the control commands to the appropriate remote sessions 36 residing on the respective one or more remote computers 33. The host computer 31 may execute or support the host session 35 in software running on the host computer 31. The software performing the steps of the inventive method or running on the host computer 31 may be referred to as the host session 35. The host session 35 may be embodied in a web browser, chat application, or other software program installed on the host computer 31. The host session may enable, facilitate, or otherwise create the connection of the host computer 31 to the network 32.

Each of the one or more remote computers 33 may execute or support the respective remote sessions 36 in software running on each of the one or more remote computers 33. The software performing the steps of the inventive method or running on the one or more remote computers 33 may be referred to as the remote session 36. The remote session 36 may be embodied in a web browser, chat application, or other software program installed on the one or more remote computer 33. The remote session 36 may enable, facilitate, or otherwise create the connection of each of the one or more remote computers 33 to the network 32.

The host computer 31 may connect to the one or more remote computers 33 directly or via a server. In embodiments utilizing a server, the control commands may be relayed to the server, with the server sending the control commands to the appropriate one or more remote computers 33. In embodiments without a server, the control commands may be sent to each of the one or more remote computers 33.

In some embodiments, the control command may be received by a server, The server may evaluate the control command. The server may transform the control control command and pass this transformed control command on to the remote session 36 for execution. By way of example, and not as a limitation, an alias such as resize( ) may be sent to the server, which may create a javascript code, or the like, in response to the control command. The javascript code may be the transformed control command. This javascript code may be send to the remote session 36 for execution.

An application, including, but not limited to, the remote session 36, running on each of the one or more remote computers 33 may validate the control commands received by the respective one or more remote computers 33 to determine if the control commands violated security policies in place on the respective one or more remote computers 33. Provided no security policies prevent the execution of the control commands, the respective one or more remote computers 33 or remote sessions 36 receiving the control command may execute the control commands. The execution of the control commands may result in one or more change to the appearance of the remote session 36, which may be a browser or other application running on the remote computer 33. Additionally, the execution by the one or more remote computers 33 of the control command may result in changing data displayed by the remote session 36. The one or more control commands may be executed without the need for any interaction from a remote user 439.

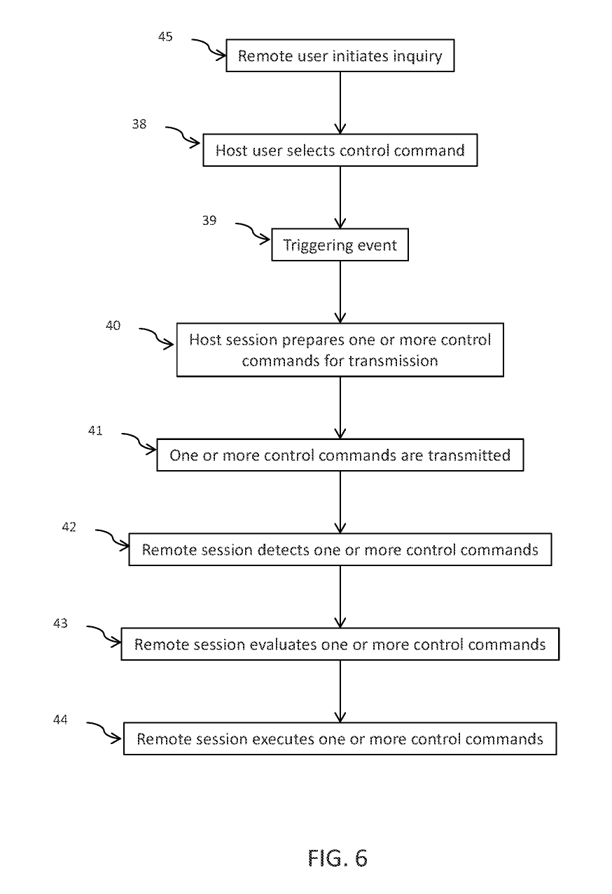

In one embodiment, as shown in FIG. 6, a remote user may request information from a host user 45. In response to the inquiry, the host user may provide one or more control commands in the host session 38. This control command may be provided by the host user inputting the control command, selecting the control command from a list of possible control commands, or like. In one embodiment, there may be one or more events that occur in the host session, which may trigger the one or more control commands to be sent to one or more remote sessions 39. By way of example, and not as a limitation, triggering events, including hovering a cursor over an element, selecting an element, or scrolling down a display, may send one or more control commands to one or more remote sessions. The host session may facilitate providing this control command to one or more remote sessions. In one embodiment, the host session may prepare the one or more control commands for transmission to the remote session 40. The control command may be relayed to a server or otherwise transmitted to the one or more remote sessions 41. The remote session may detect that a control command has been directed to it 42. Upon detection of the control command, the remote session may evaluate the control command 43. In one embodiment, the control command may be evaluated for purposes, including, but not limited to, determining if execution of the control command violates remote session policies, determining if the control command is intended for the remote session, determining if the control command is responsive to the remote user's request, or the like. The remote session may execute the control command 44.

In one embodiment, the host user of the host computer may send one or more control commands to a server. The server may direct the one or more control commands to one or more remote computers. The one or more remote computers may execute the one or more control commands.

In one embodiment, the host session may retain a log of control commands sent by the host session. The remote session may retain a log of control commands executed by the remote session. The respective logs may allow the remote session or host session to revert to a state similar or identical to a state existing at some time prior to execution, sending, or receipt of one or more control commands. Reverting to a prior state may cause the host user, host session, remote session, or remote user to be notified of the reversion.

In accordance with one embodiment of the invention, there is disclosed a system and method for the host user to modify the remote session comprising an internet web browser, web browser pages or application, and web server all connected by an internet connection. Internet web browsers, web browser pages or applications, and web servers may comprise the host session or remote session. The Internet web browser used for this invention can be any known browser including, but not limited to, Internet Explorer, Firefox, Opera, Safari, and Chrome. A host user may use any of the web browsers, one or more remote users may also use the same or different web browsers, and the inventive method may be accomplished across multiple platforms of web browsers.

Additionally, any standard operating system can be used on either the host computer or the remote computer to accomplish the invention, including, but not limited to, Microsoft Windows operating systems, Mac OS operating systems, and Linux and Linux-based operating systems. More specifically, a host computer may use any known operating system while the remote computer may use the same or different operating system. Similarly, the host computer may implement the host session in any known web browser or other application and the remote session may be in the same or different web browser or other application.

In the present invention, no specific software application or executable is required to be downloaded or installed by either the host or remote user on either the host or remote computer.

In one embodiment of the present invention, the remote session may send a log or variables, including, but not limited to, screen dimensions to the host session. The host session may alter, modify, or otherwise provide control commands to the remote session based on or in response to the information received from the remote session.

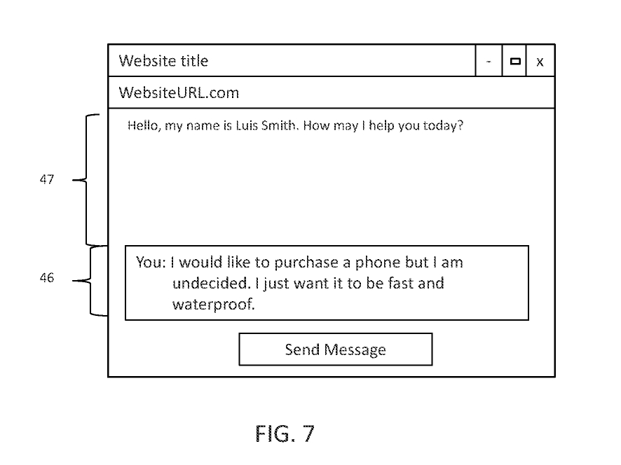

FIG. 7 illustrates one possible embodiment of a screenshot as viewed by one or more remote users. The one or more remote users may send messages to a host user, which may include, but is not limited to, a customer service representative. The messages sent to the host user may be entered in remote user section 46 of a chat view. The host user may respond to the one or more remote users and the host user's communication to the one or more remote users may appear in the remote chat dialog section 47 of a chat view, The one or more remote users may send requests to the host user, which may include, but are not limited to, requests for information.

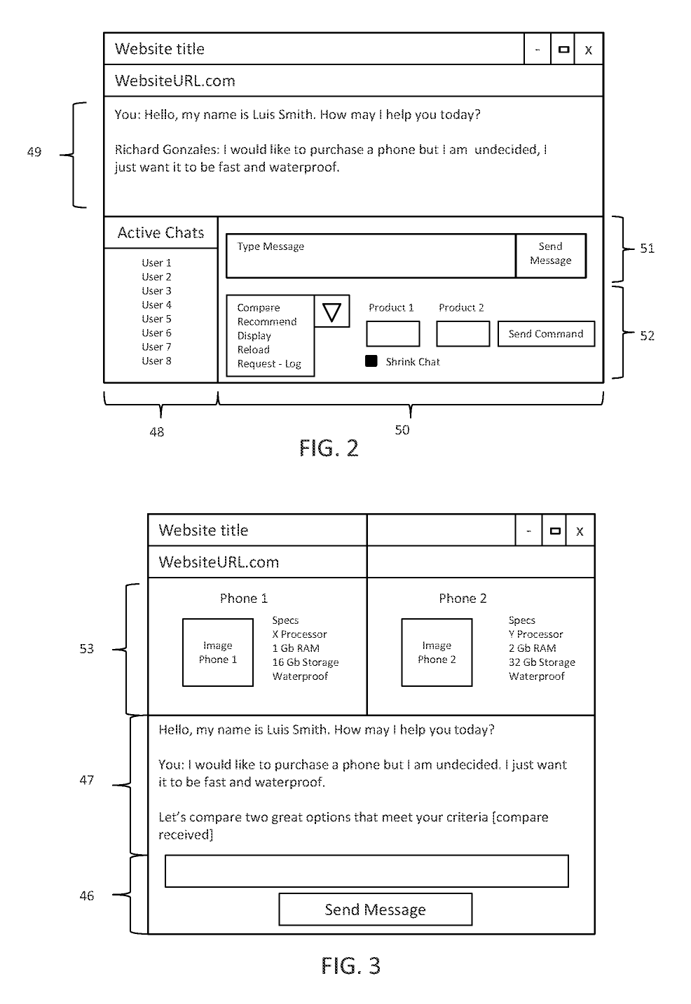

FIG. 2 illustrates one possible embodiment of a screenshot as viewed by a host user. The host user may utilize a single host session to manage interactions with one or more remote sessions. Active chats section 48 may display identifying information about each of the one or more remote sessions with which the host user is currently interacting. The host user may select one or more of the remote sessions displayed in active chats section 48. The most recent communication or information exchanged in the one or more selected remote sessions may be displayed in the host chat dialog section 49. The host user may enter, or otherwise select in the host user response area 50, information that will be provided to the one or more remote users. Information entered into, or otherwise provided to, the host user response section 50 may include control commands. The host user may input a text response or communication to the one or more remote users in the host user message response section 51. A control command may be selected from a predetermined list of possible control commands. This predetermined list may be presented to the host user in the host user control command selection section 52. In some embodiments, the host user may enter control commands in the host user control command selection section without choosing the control commands from a list of provided control commands, The host user control command selection section 52 may allow the host user to enter variables that may be provided to the remote session in combination with the one or more control commands.

FIG. 3 illustrates one possible embodiment of a screenshot as viewed by a remote user. The view as depicted in FIG. 3 may be provided to the remote user after receiving a control command from the host user. The remote user may initiate a request for more information about one or more options about which the host user may have information, A plurality of options may be compared in response to the remote user's request. This comparison may be displayed in the remote session. The plurality of options to compare may include, by way of example, and not as a limitation, products, services, troubleshooting information, or the like.

The remote user's request may be entered into the remote user section 46 by the remote user. The request as initiated by the remote user may be displayed in the remote chat dialog section 47. One possible control command that may be sent to the remote user in response to the remote user request is a COMPARE control command. The host user may enter or otherwise select the COMPARE control command and provide one or more variables which indicate what one or more items are to be compared, displayed, or otherwise presented to the remote user. In response to receiving the COMPARE control command, the remote session may change in appearance and display information to the remote user as directed by the host user through the use of one or more control commands and, optionally, one or more variables. In one embodiment, the remote chat dialog section 47 may be resized to allow display space for the host directed remote display section 53. The host directed remote display section 53 may provide information to the remote user as directed by the host user. In one embodiment, the host directed remote display section 53 may display information related to two or more different products in response to a remote user inquiry about one or more of the displayed products or an inquiry about one or more products similar or related to the one or more displayed products. The one or more control commands provided by the host user to the remote user may resize the remote chat dialog 47 and remote user sections 46 to occupy only half of the display of the remote device or remote session. The control command may direct the remote session to add one or more additional elements to the remote session display. In the event that the control command is a compare command, the remote session may be directed to display an additional two elements in the host directed remote display section 53. These additional elements may display products to be compared allowing the host user to provide additional information about the products and conduct back and forth dialog with the remote user utilizing the host and remote chat dialog sections 49, 47 respectively. This may provide a better customer experience to the remote user.

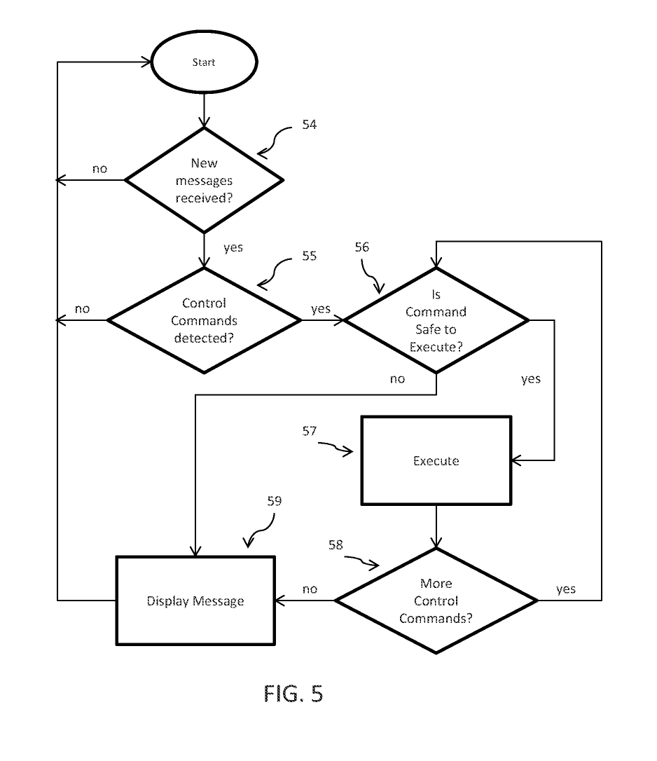

FIG. 5 depicts a flowchart of one embodiment of the process by which the remote session receives and/or executes messages or commands. The remote session may wait until it receives a new message directed to the remote session by the host session 54. If no message is received from the host session, the remote session may continue checking for messages from the host session. If a message is received from the host session, the remote session may determine whether one or more control commands are contained in that message 55. In the event that one or more control commands have been received by the remote session, the one or more control commands may be checked for safety 56. Provided the control command meets the security requirements of the remote session, the remote session may execute the control command 57. The remote session may evaluate the message from the host session to determine if one or more unexecuted control commands remain 58. If one or more unexecuted control commands remain in the message from the host session, the one or more unexecuted control commands may be evaluated for compliance with remote session security requirements 56. This may continue until no unexecuted control commands remain. If there is no control command contained in the message from the host session, one or more received control commands do not meet the security requirements of the remote session, or all of the received control commands have been executed by the remote session, the remote message may display text 59. The displayed text may be text received from the host session, may be displayed to inform the remote user of the status of the remote session, or for similar purpose

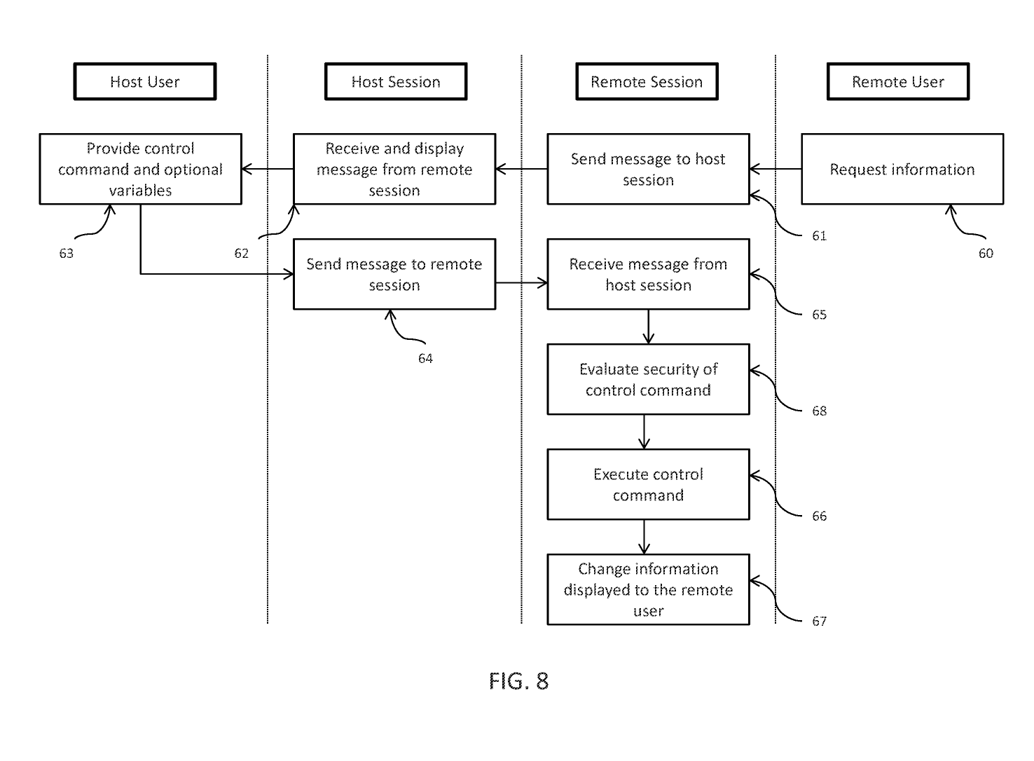

FIG. 8 provides a representation of one embodiment of the inventive method. The remote user may initiate the method by requesting information from a host user 60. The remote user request may include the remote user authorizing acceptance of information offered by a host user to the remote user. The remote user request may also include implied requests for information. The request by the remote user is not required to be an explicit request for information. The remote session may send a message containing the remote user's request to the host session 61. The host session may receive and display, or otherwise indicate, a request from the remote user, 62. In response to the remote user's request, the host user, which may be a human, may provide or otherwise select one or more control commands and, optionally, variables to be supplied to the remote session 63. The host session 64 may send a message containing the information provided by the host user to the remote session 64. The remote session may receive the message from the host session 65. The remote session may evaluate the message or control command for compliance with security policies in place on the remote session or remote computer 68. The remote session may execute the control command 66. The remote session may display information to the remote user or otherwise change the appearance of the remote session as a result of receiving the control command 67.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the description of the invention. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for displaying information on a remote computer comprising:
initiating an inquiry using the remote computer operated by a remote user in a remote session;
receiving the inquiry using a host computer operated by a host user in a host session;
providing a control command by the host user;
transmitting the control command from the host session to the remote session;
detecting the control command in the remote session; and
executing the control command in the remote session.

2. The method according to claim 1 further comprising the step of:
evaluating the control command.

3. The method according to claim 1 wherein the inquiry is initiated by the remote user.

4. The method according to claim 1 wherein the control command is executed in the remote session without interaction from the remote user.

5. The method according to claim 1 wherein the control command is selected in response to the inquiry.

6. The method according to claim 1 further comprising the step of:
selecting a variable to transmit to the remote session.

7. The method according to claim 6 wherein the host user selects the control command and variables to transmit to the remote session in response to the inquiry.

8. The method according to claim 1 wherein the remote session is a web browser.

9. The method according to claim 1 wherein the remote session is a chat application.

10. The method according to claim 1 further comprising the step of:
displaying a message in the remote session in response to receipt of the control command.

11. The method according to claim 1 further comprising the step of:
displaying a comparison of a plurality of options in the remote session in response to the control command and without interaction from the remote user.

12. The method according to claim 1 further comprising the step of:
utilizing API functions to transmit the control command.

13. The method according to claim 1 further comprising the step of:
determining if the control command is responsive to the inquiry.

14. The method according to claim 1 further comprising the step of:
retaining a log of control commands executed by the remote session.

15. The method according to claim 14 further comprising the step of:
utilizing the log to revert to a former state of the remote session.

16. The method according to claim 1 further comprising the step of:
controlling, by the host user, a plurality of remote sessions.

17. The method according to claim 1 further comprising the step of:
receiving the control command by a server; and transforming the control command by the server.

18. A method for displaying information on a remote computer comprising the steps of:
initiating, by a remote user, an inquiry in a remote session on a remote computer;
receiving the inquiry in a host session on a host computer;
determining, by a host user and in consideration of the inquiry, a control command;
providing, by the host user, the control command;
determining, by the host user and in consideration of the inquiry, a variable;
selecting, by the host user, the variable;
transmitting the control command and the variable from the host session to the remote session;
detecting the control command in the remote session; and
executing the control command in the remote session to change a visual appearance of the remote session without interaction from the remote user.

19. The method of claim 18 wherein executing the control command in the remote session changes a display area size of the remote session without interaction from the remote user.

20. A method for displaying information on a remote computer comprising the steps of:
requesting, by a remote user of a remote chat session on a remote computer, information from a host user of a host session on a host computer;
receiving a request in the host session;
determining, by the host user and in consideration of the request, a control command;
selecting, by the host user, the control command from a set of possible control commands;
determining, by the host user and in consideration of the request, a variable;
selecting, by the host user, the variable;
transmitting the control command and the variable from the host session to the remote chat session;
detecting the control command in the remote chat session; determining if the control command is responsive to the request; and
displaying a comparison of a plurality of products in the remote chat session without interaction from the remote user;
resizing a component of the remote chat session in response to the control command.
